(19) United States
(12) Patent Application Publication
(10) Pub. No.: US 2025/0348840 A1
(43) Pub. Date: Nov. 13, 2025

(54) ARTICLE TRACKING SYSTEM

(71) Applicant: NAGRAVISION SARL, CHESEAUX-SUR-LAUSANNE (CH)

(72) Inventors: Dilip Agrawal, CHESEAUX-SUR-LAUSANNE (CH); Nangina Santhosh Kumar, CHESEAUX-SUR-LAUSANNE (CH); Sagar Kumar, CHESEAUX-SUR-LAUSANNE (CH)

(73) Assignee: NAGRAVISION SARL, CHESEAUX-SUR-LAUSANNE (CH)

(21) Appl. No.: 19/204,970

(22) Filed: May 12, 2025

(30) Foreign Application Priority Data
May 13, 2024 (EP) 24175539.6

(51) Int. Cl. G06Q 10/087; G08B 13/24

(52) U.S. Cl. CPC G06Q 10/087; G08B 13/2402

(57) ABSTRACT

A system for tracking a plurality of articles in a storage compartment. Each of the plurality of articles is associated with a respective passive radio frequency, RF, tag. The system comprises a plurality of RF antennas, each RF antenna for receiving a signal from a respective passive RF tag. The system further comprises an RF reader configured to provide power to the plurality of RF antennas in sequence, and receive, from one or more of the plurality of RF antennas, response data corresponding to one or more signals received from one or more of the plurality of RF tags. The system additionally comprises a processor configured to determine whether a first article of the plurality of articles is located in the storage compartment based on the response data.

### CROSS-REFERENCE TO RELATED APPLICATIONS

This application claims the priority benefit of European Patent Application No. 24175539.6 filed May 13, 2024, which is incorporated herein by reference in its entirety for all purposes.

### FIELD OF THE INVENTION

The present invention relates to systems and methods for tracking one or more articles.

### BACKGROUND

In many environments, there can be a need to determine whether a particular article is present in the environment. For example, there may be a plurality of articles kept together in a storage compartment (e.g., a plurality of items of jewellery kept in a jewellery box), and it may be beneficial to determine which of the plurality of articles remain in the storage compartment over time, and which of the plurality of articles have been removed from the storage compartment.

Conventionally, humans were tasked with determining whether articles were present in an environment or not. They would need to repeatedly check the environment (e.g., by manually looking for the different articles) to be able to determine which articles were present and which were not. However, this approach is labour intensive and inefficient, especially when there are multiple articles to track.

It is known to track articles using radio frequency identification (RFID) technology. A radio frequency (RF) tag can be positioned on each article to be tracked, and the presence or location of the article may be determined based on Relative Signal Strength Indicator (RSSI) values measured by one or more receivers. A positioning algorithm such as trilateration or Time Difference of Arrival (TDO) techniques can then be used to determine whether a specific article is present, and/or a specific location of the article in an environment.

Bluetooth Low Energy (BLE) or Near Field Communication (NFC) technology can also be used to locate and track articles in this way.

Ultra High Frequency (UHF) is an alternative technology that can be used to identify the presence of an article at larger distances compared to regular RFID (e.g., Low Frequency RFID, or High Frequency RFID). For example, UHF tags can be read by receivers from distances up to 8-10 metres.

However, each of these approaches have disadvantages, especially when multiple articles are positioned in close proximity to one another (e.g., together in a storage compartment or box).

When RF tracking is used to track a plurality of articles positioned in close proximity to each other, multiple tags may reflect their respective signals back to the RF receiver at the same time. The RF receiver is then unable to differentiate these different signals from the respective tags, and the RF receiver is therefore unable to determine which tags, and thus which articles, are present, or no longer present. This is known as RFID collision.

UHF readers are much more expensive than RFID readers, and if the plurality of articles are positioned in a closed storage compartment, a UHF receiver positioned outside of the closed storage compartment may be unable to receive signals from the UHF tags, and thus unable to determine the presence or location of the articles.

BLE tags are often too large to be used on smaller articles. In comparison, RF tags can be small enough to be positioned on smaller article such as items of jewellery, spectacles, perfume, make up or medicine, for example. They can also be printed as paper tags, thus reducing the cost and labour associated with providing RF tags for each of a plurality of assets.

The present invention has been devised in light of the above considerations.

### SUMMARY OF THE INVENTION

According to a first aspect, there is provided a system for tracking a plurality of articles in a storage compartment, each of the plurality of articles associated with a respective passive radio frequency, RF, tag, the system comprising:
a. a plurality of RF antennas, each RF antenna for receiving a signal from a respective passive RF tag;
b. an RF reader configured to:
i. provide power to the plurality of RF antennas in sequence; and
ii. receive, from one or more of the plurality of RF antennas, response data corresponding to one or more signals received from one or more of the plurality of RF tags; and
c. a processor configured to determine whether a first article of the plurality of articles is located in the storage compartment based on the response data.

In this way, and in particular as power is provided to the plurality of RF antennas in sequence, the RF antennas generate RF waves at different times. The RF tags then receive RF waves from a corresponding RF antenna at different times to one another, and in turn also transmit a signal in response to receiving the RF waves at different times to one another. Therefore, the RF antennas receive the signals from their respective RF tag at different times to one another. RFID collision is therefore reduced, thus allowing the processor to determine which RF tags are present in the storage compartment, and also which RF tags are not present in the storage compartment.

As each article is associated with its own respective RF tag, by determining which of the RF tags are present in the storage compartment, the processor can also quickly determine which of the articles are present in the storage compartment, and also which of the articles are not present in the storage compartment.

Optional features will now be set out. The following optional features are combinable singly or in any combination with any aspect of the invention.

The storage compartment may be a box, such as a display box or storage box for example, or a tray. The articles may be items of jewellery, spectacles, perfume, make up, medicine, or other small articles which can be stored together in a storage compartment.

Each passive RF tag may be positioned on or attached to a respective article. For example, when the articles are items of jewellery, each item of jewellery may have its own respective RF tag attached thereto. Passive RF tags may be understood as RF tags that do not have their own power source, but which transmit signals in response to receiving (e.g., radio frequency) energy from an RF antenna. The passive RF tags may comprise paper RF tags, for example.

The one or more signals received from one or more of the RF tags may be received at one or more of the plurality of RF antennas. The one or more signals may be RF signals, e.g., electromagnetic signals including radio waves with frequencies of 300 GHz and below. For example, a RF signal may include one or more electromagnetic waves in the frequency range from (approximately) 20 kHz to 300 GHz.

The storage compartment may comprise a surface for supporting the plurality of articles in the storage compartment. For example, an internal surface formed by a base of the storage compartment may comprise the surface for supporting the plurality of articles.

The system may further comprise the storage compartment.

The RF antennas may be positioned within the storage compartment. In some examples, the RF antennas may be positioned in the base of the storage compartment (e.g., such that when the plurality of articles are placed in the storage compartment, the plurality of articles are each positioned above a respective RF antenna). In some examples, the RF antennas may be positioned in a lid of the storage compartment (e.g., such that when the plurality of articles are placed in the storage compartment, the plurality of articles are each positioned below a respective RF antenna).

The RF antennas may be attached to an internal surface of the storage compartment. In this way, the RF antennas can be located closer to the plurality of articles, improving the strength of the signals transmitted between the RF tags and the RF antennas, and thus the accuracy of the system. The RF antennas may be attached to the internal surface of the base of the storage compartment. In some examples, the RF antennas may be attached to an internal surface of the lid of the storage compartment.

The RF antennas may be embedded (e.g., completely, on all sides) within the base of the storage compartment. The RF antennas may be embedded in the base at a depth of 2 cm or less from the surface for supporting the plurality of articles in the storage compartment. The RF antennas may be embedded in the base at a depth of 1.5 cm or less, more preferably 1 cm, more preferably 0.5 cm or less, from the surface for supporting the plurality of articles in the storage compartment.

The plurality of RF antennas may be positioned in the storage compartment as a 2D arrangement (e.g., grid) of individually controlled antennas (e.g., a planar array of individually controlled antennas). The antennas may be equally spaced from one another. Alternatively, they may be irregularly spaced from one another. Each RF antenna may be individually connected to the RF reader, such that the RF reader can supply power to each RF antenna in sequence.

The surface for supporting the plurality of articles in the storage compartment may be (substantially) parallel to the plane of the 2D arrangement (e.g., grid) of individually controlled antennas.

The 2D arrangement (e.g., grid) of antennas may be positioned directly above or beneath the surface for supporting the plurality of articles in the storage compartment. The system may further comprise a plurality of locators for indicating preferred positions for the plurality of articles in the storage compartment. As such, each locator may indicate a preferred position for a respective article of the plurality of articles.

Each locator may directly overlie a respective RF antenna. For example, each locator may be positioned directly above or directly below a respective RF antenna. In this way, when the articles are placed in the storage compartment, each RF tag attached to a respective article is positioned directly above or beneath a respective RF antenna.

In this way, each RF antenna can receive a signal from a respective RF tag by virtue of a respective article (with the RF tag attached thereto) being located close (e.g., adjacent) to a respective passive RF tag. This helps to further reduce RFID collision.

In some examples, the surface for supporting the plurality of articles may comprise the plurality of locators.

The plurality of locators may comprise a grid of locators. In these examples, the grid of locators may directly overlie the 2D grid of antennas such that each locator directly overlies a respective RF antenna.

Each RF antenna may be a loop antenna. The RF antennas may be orientated such that a plane including the loop antenna is (substantially) parallel to the surface for supporting the plurality of articles in the storage compartment.

Corresponding locators may be positioned to overlie the centres of the loop antennas. Accordingly, when articles are positioned at the locators, each article will be positioned directly above/below a centre of a respective loop antenna. This ensure that a stronger signal is received at the loop antenna from the RF tag associated with the article.

The system may comprise a single RF reader. The single RF reader may be connected to all the RF antennas. This reduces the cost and complexity of the system as a single RF reader can transmit and receive signals from multiple antennas, and as such each antenna does not require its own RF reader.

Alternatively, the system may comprise a plurality of RF readers, each RF reader connected to a respective subset of the RF antennas.

The/each RF reader may be positioned in or on the storage compartment. For example, the RF reader may be attached to the storage compartment, e.g., to an interior surface thereof.

The system may comprise more than 5 RF antennas, more than 10 RF antennas, more than 20 RF antennas, more than 50 RF antennas, or more than 100 RF antennas, for example. It may be preferable that the number of antennas is equal to the number of articles in use. The number of locators may equal the number of RF antennas.

Each RF tag may be associated with a unique identifier (e.g., a value). In this way, each RF tag can be identified from the other RF tags. Accordingly, the signal received from each RF tag may comprise the RF tag's corresponding identifier. The unique identifier may be encoded or modulated on a given frequency in the signal from each respective RF tag.

For completeness, the RF antennas may not be tag-specific (e.g., they may be able to receive signals from any RF tag placed in close proximity thereto). Alternatively, the RF antennas may be tag-specific such that each RF antenna only receives/recognises a signal from its corresponding RF tag.

The processor may be configured to determine whether the first article is present based on whether the unique identifier for that respective tag is present in the response data. For completeness, if all of the articles are present in the storage compartment, the response data includes data corresponding to signals received at all of the RF antennas, wherein each signal is received at a respective RF antenna from a respective passive RF tag. If only some of the articles are present in the storage compartment, only some of the RF antennas will receive signals from an RF tag, and so the response data will only include signals received from those RF antennas.

The processor may be configured to determine that the first article is present in the storage compartment if the response data includes the unique identifier corresponding to the first article. The processor may be configured to determine that the first article is not present in the storage compartment when the response data does not include the unique identifier corresponding to the first article.

The processor may be configured to determine that the first article has been removed from the storage compartment based on a determination that the first article is not present in the storage compartment, and stored data. The stored data may comprise information indicating that the first article was previously present in the storage compartment and/or information indicating that the first article should be present in the storage compartment (e.g., a predefined inventory of articles that should be located in the storage compartment).

The processor may be configured to determine which articles of the plurality of articles are located in the storage compartment based on the response data. By comparing this determination to a predefined list of articles that have previously been located in the storage compartment and/or a predefined list of articles that should be located in the storage compartment, the processor may be configured to determine which articles of the plurality of articles are or are not present in the storage compartment.

The processor may be configured to provide user feedback relating to which of the plurality of articles are (or are not) located in the storage compartment. The user feedback may be provided to a connected device, such as a connected mobile device (and in particular, a mobile application of the mobile device, for example). This user feedback may be for display at the connected device. Accordingly, the system (and in an example, the processor) may be communicatively coupled to a connected device, such as a mobile device. As such, the processor may be configured to transmit data relating to user feedback to a connected device, for display thereon. The mobile device, and in particular the mobile application, can therefore provide feedback to the user about which articles are currently present in the storage compartment, and/or which articles are not present in the storage compartment. The mobile device may provide feedback to the user about which articles have been removed from the storage compartment (e.g., compared to previous feedback indicating that those articles were located in the storage compartment).

The processor may continuously provide user feedback (e.g., to the connected device). Alternatively, the processor may intermittently (e.g., periodically) provide user feedback (e.g., to the connected device). The processor may be configured to communicate with the connected device via a wireless communications module (e.g., WiFi or BLE), a gateway, and/or a remote server, for example.

The processor may be configured to trigger an alarm in response to a determination that the first article is not located in the storage compartment, and/or has been removed from the storage compartment, based on the response data.

In this way, feedback that the first article is missing or has been removed from the storage compartment can be quickly provided to the user. This can be useful for security reasons (e.g., to alert a user when an item of jewellery has been removed from a display box) or for asset tracking between storage compartments, for example.

The processor may be configured to trigger the alarm at a connected remote device, such as a connected mobile device, for example. In these examples, the processor may be wirelessly coupled to the mobile device, and in particular a mobile application running on the mobile device. Accordingly, when the processor determines that the first article has been removed from the storage compartment, an alert may be triggered at the mobile device to provide feedback to the user. Alternatively/additionally, the processor may be configured to trigger an alarm at the storage compartment itself.

The alert may comprise visual, haptic, and/or audible feedback.

The processor may be located at a remote computing device or server (e.g., a server at a different location to the storage compartment). In these examples, the RF reader may be configured to transmit the response data to the remote computing device/server. The processor at the remote computing device/server may then be configured to determine whether the first article is or is not located in the storage compartment based on the response data.

The processor may be located with the RF reader (e.g., at the same location as the RF reader, in the storage compartment). In some examples, the RF reader may comprise the processor.

As mentioned above, the RF reader is configured to provide power to the RF antennas in sequence, in order to avoid RFID collision. The system may comprise a relay to individually power the RF antennas in sequence. Power may be supplied to each RF antenna for a duration of between 10-50 ms, between 20-40 ms, or more preferably approximately 30 ms, for example.

The RF reader may be configured to (continuously) cyclically provide power to the plurality of RF antennas (e.g., such that power is always provided to at least one of the RF antennas). This may ensure that efficient feedback is provided to the user when an article is added or removed from the storage container.

The RF reader may be configured to intermittently (e.g., periodically) provide power to the RF antennas in sequence, e.g., once every predefined interval. For example, the RF reader may provide power to the plurality of RF antennas in sequence once every 10 seconds, every 60 seconds, every 5 minutes, every hour for example. Optionally, how often power is supplied to the plurality of RF antennas may depend on the time of day; e.g., power may be provided to the RF antennas less often at night compared to during the day. This may reduce power consumption of the system.

The system may further comprise one or more sensors. The RF reader may be configured to provide power to the plurality of RF antennas in sequence, in response to a sensor measurement (e.g., of the sensor) meeting a predefined criterion. The predefined criterion may be a predefined threshold, for example. In this way, the one or more sensors are used to trigger reading of the RF tags by the RF reader. In this way, power consumption of the system can be reduced, and battery life improved. In some examples, the system may comprise a plurality of sensors.

The one or more sensors may comprise one or more of a movement sensor, a light sensor, a proximity sensor, an IR sensor, a tilt sensor, for example. In this way, the RF reader may be triggered to read the RF tags only when user movement, and/or user proximity is detected.

The storage compartment may have an inner volume of less than 1 m³, less than 0.5 m³, or less than 10 cm³, for example. The surface for supporting the plurality of articles may have an area of less than 1 m², less than 0.5 m², less than 30 cm², less than 10 cm², for example.

According to a second aspect, there is provided a method for tracking a plurality of articles in a storage compartment, each of the plurality of articles associated with a respective passive radio frequency, RF, tag of a plurality of passive RF tags, the method comprising:
providing power to a plurality of RF antennas in sequence, wherein each RF antenna is for receiving a signal from a respective passive RF tag of the plurality of passive RF tags;
receiving, from one or more of the RF antennas, response data corresponding to one or more signals received from one or more of the plurality of passive RF tags; and
determining whether a first article of the plurality of articles is located in the storage compartment based on the response data.

The method may further comprise receiving, at one or more of the plurality of RF antennas, the one or more signals received from one or more of the plurality of passive RF tags.

The method of the second aspect may be performed using the system of the first aspect.

The invention includes the combination of the aspects and preferred features described except where such a combination is clearly impermissible or expressly avoided.

### BRIEF DESCRIPTION OF THE DRAWINGS

Embodiments and experiments illustrating the principles of the invention will now be discussed with reference to the accompanying figures in which:

FIG. 1 is a schematic of a system for tracking a plurality of articles in a storage compartment;

FIG. 2 is another schematic of a system for tracking a plurality of articles in a storage compartment;

FIG. 3 is an example circuit diagram of circuitry included in a system for tracking a plurality of articles in a storage compartment; and

FIG. 4 is a flow diagram of a method for tracking a plurality of articles in a storage compartment.

### DETAILED DESCRIPTION

Aspects and embodiments of the present invention will now be discussed with reference to the accompanying figures. Further aspects and embodiments will be apparent to those skilled in the art. All documents mentioned in this text are incorporated herein by reference.

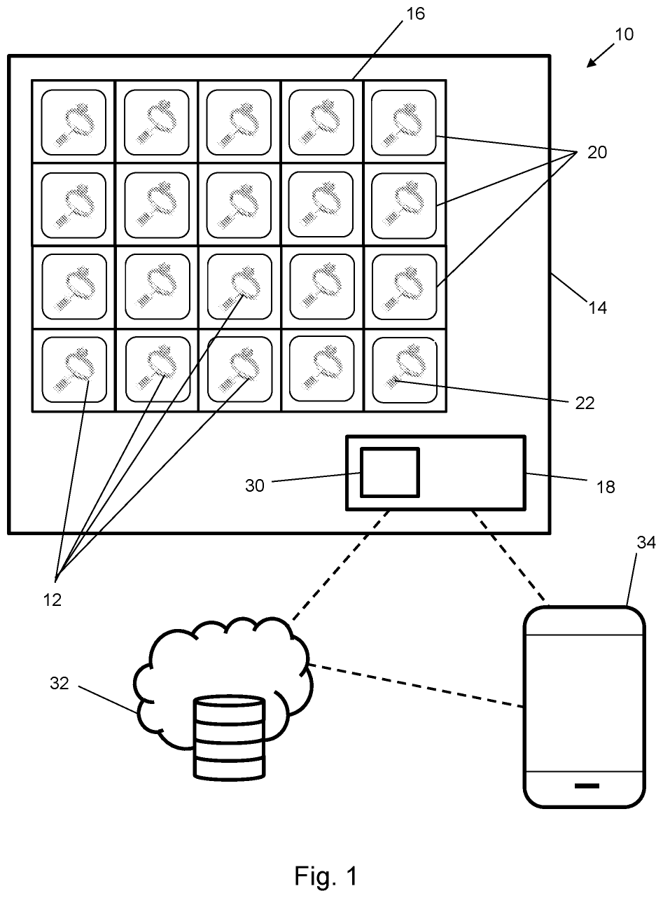

A schematic diagram of a system 10 for tracking a plurality of articles 12 is shown in FIG. 1. The system 10 may be for tracking any type of article, wherein the articles are stored together in close proximity. For example, the system may be for tracking items of jewellery in a jeweller's display, spectacles/glasses in an optician's display, perfume and/or make up in a shop display, and/or other articles that can be stored and/or displayed together. The system 10 may be for tracking the number of articles 12 present in the storage compartment and/or for tracking which of the plurality of articles 12 are present e.g., over time.

The articles 12 can be stored in a storage compartment 14. The storage compartment 14 may be a storage box or tray. The storage compartment 14 may have a base, side walls and/or a lid. It may be used for displaying the articles 12 therein. The articles 12 can be positioned on a support surface 16 of the storage compartment 14. The support surface 16 may be an internal surface of the storage compartment 14, e.g., an internal surface of the base of the storage compartment 14. The support surface 16 may comprise a plurality of surfaces, e.g., where the articles 12 are positioned on a staggered display.

The support surface 16 may comprise a plurality of locators (not shown) for indicating preferred positions of the articles 12 in the storage compartment 14. Each locator may indicate a preferred position for a single article 12. The locators may comprise marks on the support surface 16, and/or holders for the articles, for example.

The system 10 also comprises a radio frequency (RF) reader 18. The RF reader 18 may be configured to transmit and receive RF signals, via a plurality of RF antennas, as discussed in detail below. RF signals may be understood as electromagnetic signals including radio waves with frequencies of 300 GHz and below. For example, a RF signal may include one or more electromagnetic waves in the frequency range from (approximately) 20 kHz to 300 GHz.

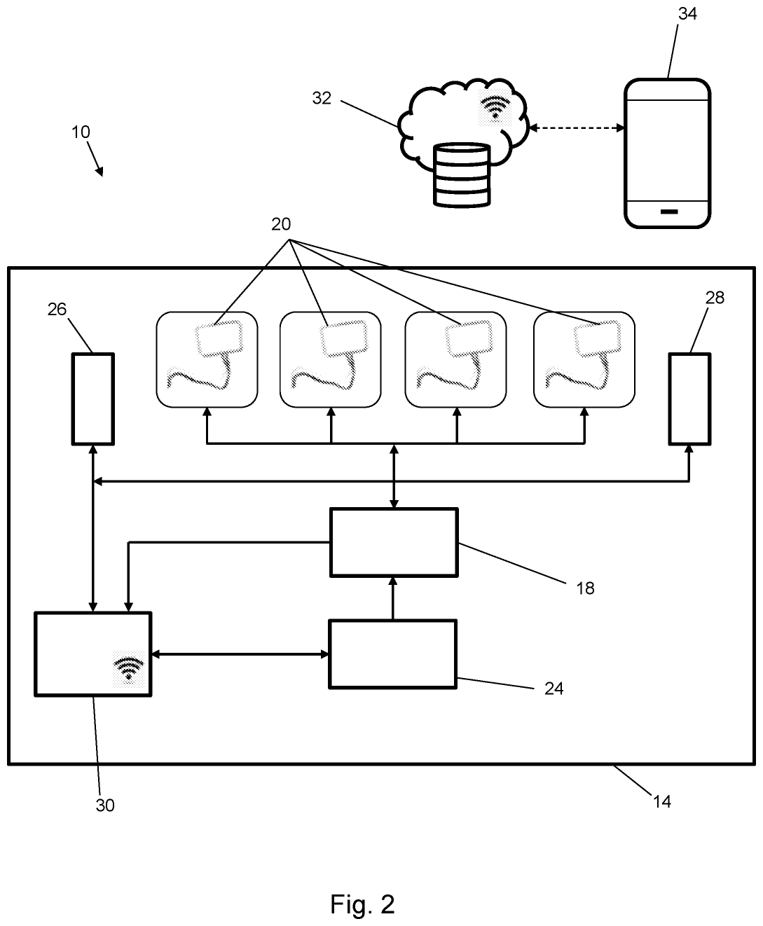

In the examples shown in FIGS. 1 and 2, the RF reader 18 is located at the storage compartment 14. It may be attached to a surface of the storage compartment 14 (e.g., an interior or exterior surface) or may be embedded within the thickness of the base, walls or lid of the storage compartment 14.

The RF reader 18 is connected (e.g., communicatively coupled) to a plurality of RF antennas 20, e.g. by one or more wired connections. The RF antennas 20 may be loop antennas, e.g., such as those shown in FIG. 2. The RF reader 18 is configured to provide power to each of the RF antennas 20, and to receive, from each of the RF antennas 20, signals that are received at the RF antennas 20 from RF passive tags attached to the plurality of articles 12.

In particular, each article 12 may have a passive RF tag 22 (e.g., a paper RF tag) attached thereto or positioned thereon. The system 10 can track a specific article of the plurality of articles 12 based on a signal received from the passive RF tag 22 attached to that specific article 12 (as discussed in detail below). In the example shown in FIG. 1, each article 12 is an item of jewellery, specifically a ring, and each ring has its own paper RF tag attached thereto.

The RF tags 22 are passive, meaning that they do not each have their own power source, but they instead can transmit signals in response to receiving power from the RF reader 18 via the RF antennas 20.

The system may comprise 2 or more RF antennas, 5 or more RF antennas, 10 or more RF antennas, 20 or more RF antennas, 50 RF or more antennas, or 100 or more RF antennas, for example. As each RF antenna receives one or more signals from a respective passive RF tag, the number of RF antennas in the system may be equal to the number of articles which are to be tracked by the system.

The RF antennas 20 may be positioned within the storage compartment 10. In operation, each RF antenna 20 is configured to receive one or more signals from a respective passive RF tag 22. As such, in use, the articles 12 (and thus the passive RF tags 22) should each be positioned in close proximity to a respective RF antenna 20. Therefore, each RF antenna 20 may be positioned in proximity to a respective locator for locating a preferred position of an article 12. In other words, each locator may indicate a position of a respective RF antenna 20. In this way, when an article is positioned in the storage compartment 14 at or near a locator, the article will be positioned in close proximity to an RF antenna 20.

There may be an equal number of locators as there are RF antennas 20. Similarly, there be an equal number of locators as there are articles to be tracked by the system 10.

Positioning the articles 12 in close proximity to the RF antennas 20 improves the strength of the signals received at the RF antennas 20 from the passive RF tags 22 attached to the articles 12. Therefore, the RF antennas 20 may be attached to an internal surface of the storage compartment, e.g., an internal surface of the base, wall and/or a lid of the storage compartment 14. The RF antennas 20 may be embedded within one or more recesses of an internal surface of the storage compartment (e.g., such that at least part of each RF antenna is exposed). They may be embedded within one or more recesses of the support surface 16, for example. They may be completely embedded within the base, walls and/or a lid of the storage compartment 14. In these examples, it may be important to embed the RF antennas close to the support surface 16, e.g., at a depth of 2 cm or less, 1.5 cm or less, 1 cm or less, or 0.5 cm or less from the support surface 16.

The plurality of RF antennas 20 may be positioned in the storage compartment 14 as a 2D arrangement. In an example such as that shown in FIG. 1, the RF antennas 20 may be arranged in a 2D grid or matrix of antennas. The support surface 16 may be substantially parallel to the 2D grid of RF antennas. In these examples, the 2D grid of antennas 20 may be positioned directly above or beneath the support surface 16, or the 2D grid of antennas 20 may be attached to the support surface 16.

Each locator may directly overlie a corresponding RF antenna. Thus, when an article is placed at a locator, that article may directly overlie (e.g., positioned directly above or directly below) an RF antenna.

The plurality of locators may comprise a corresponding arrangement to the arrangement of the RF antennas 20, e.g., a corresponding 2D arrangement, or grid. As such, the 2D grid of locators may directly overlie the 2D grid of antennas such that each locator directly overlies a respective RF antenna.

For example, the term “overlie” should be understood as meaning being co-planar, or being positioned directly above or below. As such, in examples where the RF antennas 20 are located in a lid of the storage compartment 14, the locators on an interior surface of the base of the storage compartment may still overlie the RF antennas when the lid of the storage compartment is closed and thus positioned directly above the base of the interior surface of the base.

In examples where the RF antennas 20 are loop antennas, positioning the articles 12 in the centre of the loop of each antenna may improve the signal received at the loop antenna from the RF tags 22 attached to the articles 12. As such, locators may be positioned in the storage compartment 14 to indicate a position overlying the centres of the loops of the RF antennas 20. Therefore, when an article 12 is positioned at a locator it may be positioned to directly overlie the centre of the loop of a loop antenna. The loop RF antennas may be orientated such that a plane including the loop of the antenna is (substantially) parallel to the support surface 16.

In the examples shown in FIG. 1 and FIG. 2, the system 10 comprises a single RF reader 18 connected to all of the plurality of RF antennas 20. This single RF reader 18 is configured to provide power to the plurality of RF antennas 20 in sequence (e.g., so that power is provided to only one of the RF antennas 20 at any time). The RF reader 18 is also configured to receive RF signals from each of the plurality of RF antennas 20.

In other examples, the system may comprise multiple RF readers, wherein each RF reader of the multiple RF readers is connected to a respective subset of the plurality of RF antennas 20 for providing power thereto. In these examples, the multiple RF readers are still configured to provide power to the plurality of RF antennas 20 in sequence (e.g., so that power is provided to only one of the RF antennas at any time), and also receive RF signals from the RF antennas 20.

In order to provide power to the plurality of RF antennas in sequence, the system may comprise a relay 24. The RF reader 18 may be connected to the plurality of antennas 20 via the relay 24, as shown in FIG. 2, for example. The relay 24 may be configured to control the RF reader 18 to provide power to each of the RF antennas 20 in sequence. The system 10 (and in particular, the relay 24) may provide power to each RF antenna 20 for an equal duration of time. Power may be supplied to each RF antenna for a duration of between 10-50 ms, between 20-40 ms, or approximately 30 ms, for example.

The system 10 (and in particular, the RF reader 18, optionally under the control of the relay 24), may be configured to cyclically provide power to the plurality of RF antennas 20. In this way, power is repeatedly provided to the plurality of RF antennas 20 in sequence. In some examples, power may be continuously cyclically provided (e.g., such that power is always provided to one of the RF antennas at any one time). In some examples, power may be provided periodically. In these examples, there may be periods when no power is supplied to any RF antennas. The system 10 (and in particular, the RF reader 18, optionally under the control of the relay 24) may provide power to the plurality of RF antennas 20 in sequence once every 10 seconds, every 20 seconds, every 30 seconds, every 40 seconds, every 50 seconds, every 60 seconds, every minute, every 5 minutes, every 30 minutes, every hour for example. The frequency of each cycle for providing the power to the RF antennas may depend on a number of factors, such as the time of day, or day of the week for example. Accordingly, the cycles for providing power to the RF antennas may occur less frequently when the articles are less likely to be moved and therefore less likely to need to be tracked. For example, power may be provided to the RF antennas 20 less often at night compared to during the day. This reduces power consumption.

In some examples, power may be provided to the plurality of RF antennas 20 in sequence in response to a trigger event. The trigger event may be a sensor measurement meeting a predefined criterion such as a predefined threshold. Accordingly, the system 10 may further comprise one or more sensors. The one or more sensors may be configured to detect user movement and/or user proximity to the storage compartment 14. The system 10 may comprise one or more of a motion sensor, a light sensor, a proximity sensor, an infrared (IR) sensor 28, and/or a tilt sensor 26, for example. The one or more sensors may be located at the storage compartment 14. They may be attached to the storage compartment 14, for example. In these examples, the RF reader 18 may be triggered to read the RF tags 22 (by providing power in sequence and then receiving signals from the RF tags 22 in response) in response to movement/proximity detection, e.g., a user approaching the storage compartment 14. By providing power in response to a trigger event detected by a sensor, power consumption of the system can be reduced and battery life improved.

In some examples, the system may provide power to the plurality of RF antennas both periodically, and also in response to a trigger event as described above.

The system 10 also comprises a processor 30 configured to determine whether a first article of the plurality of articles is located in the storage compartment 14. The processor may be configured to determine which of the plurality of articles 12 are located in the storage compartment 14, and/or which of the plurality of articles 12 are not located in the storage compartment 14. The processor may be configured to determine the number of articles 12 located in the storage compartment.

The system 10 may also comprise a remote computing device or server 32, which may comprise cloud storage for example. The system 10 may be wirelessly connected to a mobile device 34.

The processor 30 may be located at the remote computing device or server 32, or may be located at the storage compartment 14. In some examples, at least part of the processor 30 may be located remotely (e.g., at the remote sever 32) and at least part of the processor 30 may be located at the storage compartment 14.

In some examples, the processor 30 may be connected to the RF reader 18 via a wired connection (optionally, via relay 24, as shown in FIG. 2). In some examples, the RF reader 18 itself may comprise the processor 30 for determining whether one or more articles of the plurality of articles are present in the storage compartment.

The processor 30 may be configured to determine whether a first article is present in the storage compartment 14 based on one or more RF signals received at the RF antennas 20 from one or more of the plurality of RF tags (“response data”), which may be provided to the processor 30 via the RF reader 18.

This response data depends on which articles are present in the storage compartment 14. For example, if all articles of the plurality of articles 12 are present in the storage compartment, then each RF antenna 20 would receive an RF signal from a respective RF tag 22. Then, the response data received at the RF reader 18 from the RF antennas 20 would include an RF signal from each RF antenna. If only some of the plurality of articles 12 are present in the storage compartment, only some of the RF antennas 20 would receive an RF signal, and the response data received at the RF reader 18 would only include RF signals from those RF antennas.

The processor 30 may be configured to determine the number of articles 12 present in the storage compartment 14 based on the response data (e.g., by determining the number of RF signals received at the RF antennas for example).

In some examples, each RF tag 22 may be associated with a unique identifier (e.g., a value), such that each RF tag can be identified from other RF tags. In these examples, an RF signal received from an RF tag may comprise the RF tag's corresponding identifier. The unique identifier may be encoded or modulated on a given frequency in the RF signal received from the RF tag.

The processor 30 may be configured to determine whether the first article is present in the storage compartment 30 based on whether the unique identifier for that respective tag is present in the response data. For example, if the response data includes data corresponding to the unique identifier for the first article, then the processor 30 may determine that the first article is present in the storage compartment 14. If the unique identifier corresponding to the first article is not present in the response data, then the processor 30 may determine that the first article is not present in the storage compartment 14.

The processor 30 may also use stored data in the determination as to whether the first article is present. The stored data may be stored in memory at the storage compartment 14, and/or may be stored remotely such as in cloud storage, for example at remote server 32. The stored data may comprise a list of articles which are expected to be (e.g., which should be) located in the storage compartment 14. The processor 30 may compare the response data to the stored list of articles to determine which of the articles are present, for example. The stored data may comprise historical data indicating which articles were previously present in the storage compartment. The processor 30 may compare the response data to the stored/historical data to determine which articles are present (or are not present in the storage compartment). The processor 30 may be configured to determine which articles have been removed from the storage compartment and/or added to the storage compartment based on this data.

In some examples, the system 10 may be configured to provide user feedback relating to which of the plurality of articles 12 are (or are not) location in the storage compartment 14. This user feedback may be presented to a user via the connected mobile device 34, for example. In these examples, the processor 30 may be configured to transmit data relating to user feedback to the connected mobile device 34 for display thereon. The mobile device 34 can then provide feedback to the user about which articles are currently located in the storage compartment 14, and/or which articles have been removed and/or added to the storage compartment. The user can then track which articles are present in the storage compartment 14, e.g., via a mobile application at the connected mobile device 34, over time.

In some examples, user feedback may alternatively/additionally be provided to the user at the storage compartment 14 itself, for example at a display at the storage compartment 14.

The processor 30 may be configured to trigger an alarm based on the determination of whether the first article is present in the storage compartment. For example, an alarm may be triggered in response to a determination that the first article is not located in the storage compartment when it is expected to be (e.g., if it is included in a stored list of expected articles) and/or in response to a determination that the first article has been removed from the storage compartment 14. The alarm may be triggered at the connected mobile device 34, and/or the storage compartment 14 itself. The alert may comprise visual, haptic, and/or audible feedback. For example, the storage compartment may comprise a display and/or one or more LEDs, a speaker and/or a vibrator to provide the alert/feedback.

The system 10 may further comprise a power source (not shown), such as a battery. The power source may be comprised in the storage compartment 14 for powering the components therein.

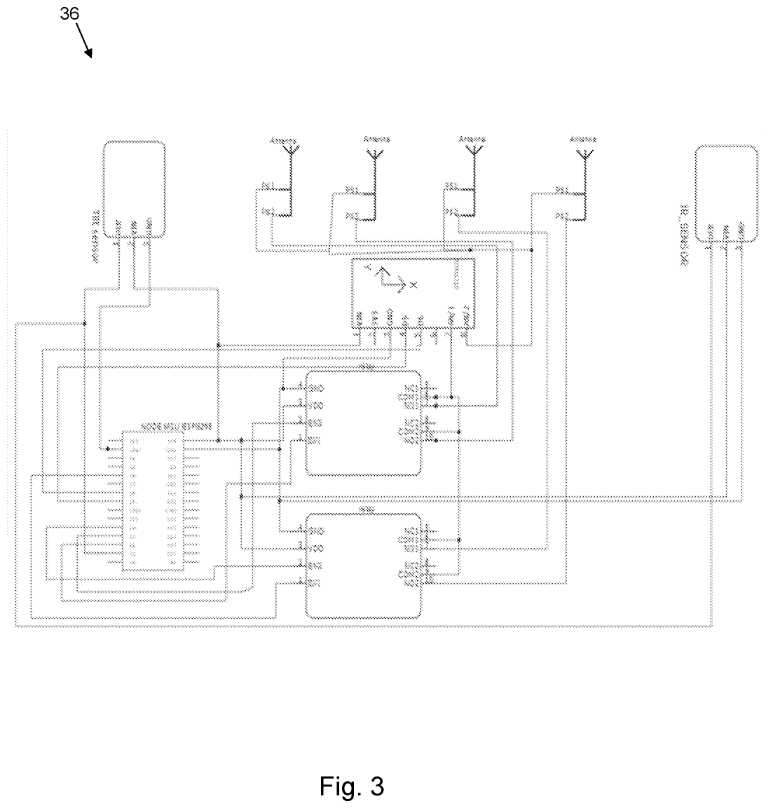

FIG. 3 is a circuit diagram 36 of example circuitry in the storage compartment 14 of FIG. 2. Processor 30 labelled “NODE MCU” in FIG. 3 may be wirelessly connected to a remote mobile device (e.g., mobile device 34 shown in FIG. 2), e.g., via a wireless communications module (e.g., WiFi or BLE), a gateway, and/or a remote server, for example.

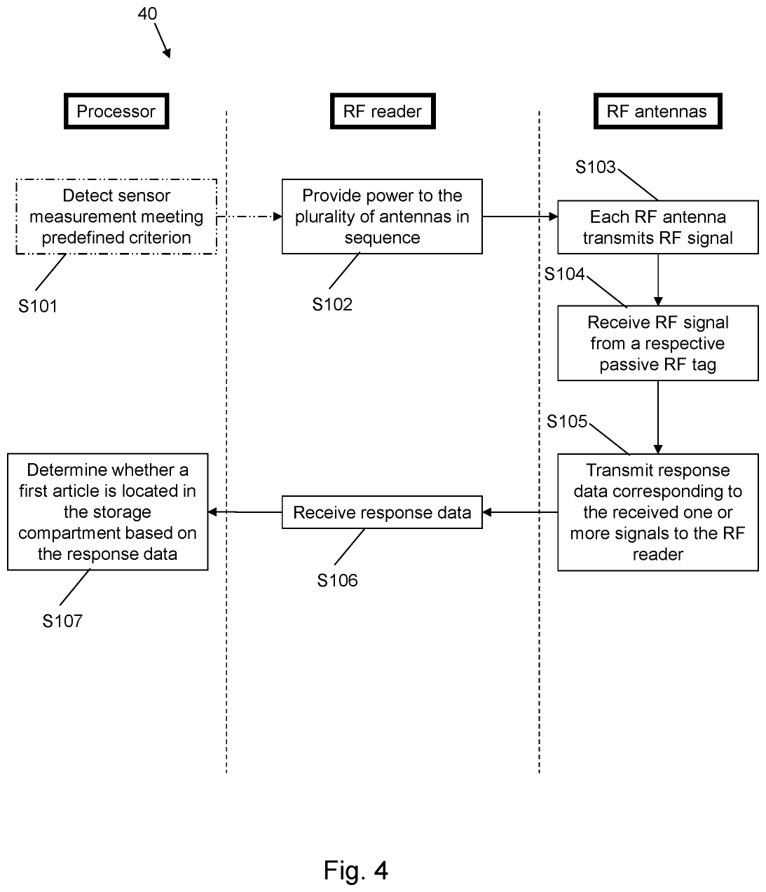

An example method 40 for tracking a plurality of articles in a storage compartment (such as the storage compartment 14 described above) is now discussed in relation to FIG. 4.

Processor 30 may trigger the RF reader 18 to read the RF tags 22 associated with the RF articles 12 present in the storage compartment. This trigger may be in response to a sensor measurement detected at a sensor on the storage compartment, such as an IR sensor 28, movement sensor or tilt sensor 26. Accordingly, the processor 30 may detect a sensor measurement as meeting a predefined criterion (S101 of FIG. 4), and in response instruct the RF reader 18 to read the RF tags 22. This step is optional. In other examples, the RF reader 18 may continuously read the RF tags, e.g., by continuously cyclically providing power to the plurality of RF antennas in sequence. The RF reader 18 may periodically read the RF tags 22.

As discussed above, the RF reader 18 is connected to a plurality of RF antennas 20. The RF reader 18 reads the plurality of RF tags 22 by providing power to the plurality of connected RF antennas 20 in sequence (S102 of FIG. 4). As discussed above, this sequential powering of the RF antennas may be implemented by relay 24 and/or by the RF antennas 20 being individually connectable to the RF reader 18.

By providing power to the plurality of RF antennas in sequence, the plurality of RF antennas 20 transmit an RF signal in sequence (S103 of FIG. 4). If an article 12, with an RF tag 22 attached thereto, is located in close proximity to a respective RF antenna 20 (e.g., because it is positioned at a corresponding locator), then the RF tag will receive the RF signal from its corresponding RF antenna and in response transmit an RF signal in return which is received by that RF antenna 20 (S104 of FIG. 4). This return RF signal may include a unique identifier for the RF tag, as described above. Each RF antenna receives an RF signal from a respective RF tag if an article is positioned in close proximity to that RF antenna (e.g., by virtue of being positioned at the locator). The RF antennas 20 can then return response data corresponding to (and in some examples, comprising) the received RF signals to the RF reader (S105 of FIG. 4). The RF reader 18 receives this response data from the RF antennas (S106 of FIG. 4). Based on this response data, the processor 30 can then determine whether a first article is located in the storage compartment 14. The processor 30 may determine the number of articles in the storage compartment, which specific articles are located in the storage compartment, and/or whether an article has been and and/or removed (and if so which article), based on the response data (which may include the unique identifiers of the RF tags present in the storage compartment), and optionally stored information about the number of articles and/or which articles should or should not be present in the storage compartment 14.

In examples where at least part of the processor 30 is located at a remote server, the RF sensor 18, and/or another processor located at the storage compartment 14 may transmit the response data to the remote server for processing.

Although not shown in FIG. 4, the method may further comprise providing user feedback and/or one or more alarms based on the determination of whether the first article is located in the storage compartment (as described above).

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A system for tracking a plurality of articles in a storage compartment, each of the plurality of articles associated with a respective passive radio frequency (RF) tag of a plurality of passive RF tags, the system comprising:
a plurality of RF antennas, each RF antenna for receiving a signal from a respective passive RF tag of the plurality of passive RF tags;
an RF reader configured to:
provide power to the plurality of RF antennas in sequence; and
receive, from one or more of the plurality of RF antennas, response data corresponding to one or more signals received from one or more of the plurality of passive RF tags; and
a processor configured to determine whether a first article of the plurality of articles is located in the storage compartment based on the response data.

2. The system of claim 1, wherein the plurality of RF antennas are positioned in the storage compartment as a 2D arrangement of individually controlled antennas.

3. The system of claim 2, wherein the storage compartment comprises a surface for supporting the plurality of articles in the storage compartment, and wherein the surface for supporting the plurality of articles in the storage compartment is parallel to a plane of the 2D arrangement of individually controlled antennas.

4. The system of claim 1, wherein the system comprises a plurality of locators for indicating preferred positions for the plurality of articles in the storage compartment.

5. The system of claim 1, wherein each RF antenna is a loop antenna.

6. The system of claim 1, wherein the system comprises a single RF reader.

7. The system of claim 1, wherein the RF reader is positioned in or on the storage compartment.

8. The system of claim 1, wherein each RF tag is associated with a unique identifier, and the processor is configured to:
determine that the first article is present in the storage compartment when the response data corresponding to the one or more signals received from the plurality of passive RF tags includes the unique identifier corresponding to the first article; and
determine that the first article is not present in the storage compartment when the response data corresponding to the one or more signals received from the plurality of passive RF tags does not include the unique identifier corresponding to the first article.

9. The system of claim 1, wherein the processor is configured to provide user feedback relating to which articles of the plurality of articles are located in the storage compartment to a connected mobile device for display thereon.

10. The system of claim 1, wherein the processor is configured to trigger an alarm in response to a determination that the first article has been removed from the storage compartment based on the response data corresponding to the one or more signals received from the plurality of passive RF tags.

11. The system of claim 10, wherein the processor is configured to trigger the alarm at a connected mobile device.

12. The system of claim 1, wherein the RF reader is configured to individually supply power to each RF antenna in sequence for a duration of between 10-50 milliseconds (ms) per RF antenna.

13. The system of claim 1, wherein the RF reader is configured to provide power to the plurality of RF antennas in sequence, in response to a measurement of a sensor meeting a predefined criterion.

14. The system of claim 13, wherein the sensor comprises one or more of a movement sensor, light sensor, proximity sensor, an IR sensor, and a tilt sensor.

15. A method for tracking a plurality of articles in a storage compartment, each of the plurality of articles associated with a respective passive radio frequency (RF) tag of a plurality of passive RF tags, the method comprising:
providing power to a plurality of RF antennas in sequence, wherein each RF antenna is for receiving a signal from a respective passive RF tag of the plurality of passive RF tags;
receiving, from one or more of the plurality of RF antennas, response data corresponding to one or more signals received from one or more of the plurality of passive RF tags; and
determining whether a first article of the plurality of articles is located in the storage compartment based on the response data.

16. The method of claim 15, wherein the plurality of RF antennas are positioned in the storage compartment as a 2D arrangement of individually controlled antennas.

17. The method of claim 16, wherein the storage compartment comprises a surface for supporting the plurality of articles in the storage compartment, and wherein the surface for supporting the plurality of articles in the storage compartment is parallel to a plane of the 2D arrangement of individually controlled antennas.

18. The method of claim 15, wherein each RF antenna is a loop antenna.

19. The method of claim 15, wherein the power is provided to the plurality of RF antennas using an RF reader.

20. The method of claim 19, wherein the RF reader is positioned in or on the storage compartment.
